(19) United States
(12) Patent Application Publication
(10) Pub. No.: US 2005/0179260 A1
(43) Pub. Date: Aug. 18, 2005

(54) Pipe clamp

(76) Inventors: Jan Sedlacek, Zatcany (CZ); Jan Blazek, Hustopece (CZ); Martin Nemrava, Praha (CZ); Petr Bezdek, Hustopece (CZ)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/514,606

(22) PCT Filed: May 17, 2002
(86) PCT No.: PCT/EP02/05514

(51) Int. Cl. F16L 25/00

(52) U.S. Cl. 285/420

(57) ABSTRACT

The invention is directed at a pipe clamp for connecting two fluid lines of different shapes, having: a first uptake region (10) for the uptake of a line of a first shape;
a second uptake region (11) for the uptake of a line of a second shape; a transition (12) for the fluid-tight connection of the two uptake regions (10, 11); a flange region (13) with end segments (14, 15) of the two uptake regions (10, 11) and of the transition (13), which form between them a clamping slot (16) that they bound on either side; and a fastening (17) for clamping the uptake regions (10, 11) around the lines at clamping slot (16). The pipe clamp according to the invention is hereby characterized in that the two uptake regions (10, 11) are eccentrically arranged relative to one another, so that the transition (12) and the uptake regions (10, 11) form a planar region next to one another without a step or gradation in the flange region (13).

The present invention concerns a pipe clamp for connecting two fluid lines. The invention particularly concerns a pipe clamp for connecting two fluid lines that have different shapes.

Pipe clamps of this type are commercially available. Here, a band-shaped sheathing is placed around two lines positioned abutting one another and these lines are clamped with bent end regions of the band by means of screws passed through these ends, so that a tightness can be achieved between the band material of the clamp and the pipes or flexible tubings taken up in the clamp. Only pipes or flexible tubings of identical diameter can be joined together in the case of these simple clamps with only one wide band wrapped around the two lines.

In a further-developed design, tubes or flexible tubings of different diameters can also be joined together by assembling clamps comprised of two uptake regions of different diameter, which are adapted to the outer diameter of each of the pipes to be clamped. The two uptake regions are joined together by a transition region. This is formed by a gradation between the two uptake regions, which [gradation] runs around the entire circumference of the pipe clamp. In the case of simple pipe clamps, the uptake regions are designed precisely as cylindrical regions, in order to best adapt to the cylindrical outer wall of the lines. Here, “cylindrical” is to be understood as a shape which does not change its distance relative to a central point in the pipe direction, for example, a round cylinder; however, it also refers to angular or oval shapes.

In order to make possible a clamping of the above-named types of pipe clamps around the lines to be taken up, pipe clamps are designed in such a way that a small distance remains between the end regions, the so-called clamping slot, which is pulled together by the actual locking mechanism to such an extent that tightness is assured at the circular band or uptake regions.

Additional tightness measures are necessary, particularly in the clamping slot, so that no fluid, whether a liquid or a gas, can escape upon abutment of the two tubes placed abutting one another, since there is no clamping band at the slot and consequently a discharge of fluid through the uptake regions cannot be prevented. A conventional tightness system contains a small tongue piece of sheet metal or the like, which is arranged in the region of the clamping slot on the inside at the walls of the pipe clamp and projects over both uptake regions, in order to be able to reliably cover the clamping slot in the region of abutment of the two pipes. In the case of simple pipe clamps for connecting lines of identical diameter, a reliable seal can be achieved in the region of the clamping slot by means of this tongue insert seal. In contrast, tightness problems still occur with such tongue inserts in the case of pipe clamps for the uptake of pipes of different diameter, due to the gradation or step that forms at the transition between the two uptake regions. The gradation or step formation that is also necessary for the tongue insert can be brought about only with extreme difficulty for a good adaptation with the gradation of the clamp itself in the transition region, so that gaps can occur here through which the liquid or particularly gases can escape. The use of particularly flexible tongue inserts has not brought about the desired tightness result.

It is thus the object of the present invention to provide a pipe clamp, which is fluid-tight also in the case of uptake of lines of different shape in the flange region, particularly at the clamping slot.

This object is solved by the creation of a pipe clamp according to the independent patent claim 1. Other advantageous configurations, details and aspects of the present invention result from the dependent patent claims, the description, and the appended drawings.

The basic concept of the invention is to configure the flange region by eccentric arrangement of the two uptake regions in such a way that the pipe clamp runs there as flat as in a pipe clamp for two pipes of identical shape.

Correspondingly, the invention is directed to a pipe clamp for connecting two fluid lines of different shapes, which has:
a first uptake region for the uptake of a line of a first shape;
a second uptake region for the uptake of a line of a second shape;
a transition for the fluid-tight connection of the two uptake regions;
a flange region with end segments of the two uptake regions and of the transition, which form between them a clamping slot that they bound on either side; and
a fastening for clamping the uptake regions around the line at the clamping slot,
whereby the pipe clamp is characterized in that the two uptake regions are eccentrically arranged relative to one another so that the transition and the uptake regions form a planar region next to one another without forming a step in the flange region.

Each of the uptake regions has a shape and dimensions which are suitable for producing a form-fitting contact with the lines to be taken up. The transition between the uptake regions intercedes between the two uptake regions and thus serves as a type of adapter for producing a through-flow from one line to the other. The transition can have an oblique wall formation in order to make possible a good through-flow of the fluid through the pipe clamp or it can run at a right angle to the uptake regions as a step, so that the two lines to be joined abut each other directly, which leads to a simpler production and better sealing capacity. A fluid-tight connection will hereby be understood such that under the operating conditions anticipated, no fluid or only a negligible amount of fluid can escape between the inner wall construction of the uptake regions and the lines. The uptake regions surround the lines almost completely; only a small region, the clamping slot, remains free in the region of the flange, and this slot is present at both uptake regions as well as at the transition, and is formed by the end segments of the uptake regions and transition, which bound one another. If the transition is a step running orthogonally to the uptake regions, it is understood that it does not have a width in the longitudinal direction of the pipe clamp, so that the transition does not contribute to the end segments. In such cases, the end segments are formed de facto only by the uptake regions.

A fastening, for example, of conventional design, serves for the purpose of clamping the uptake regions, regulating the width of the clamping slot and achieving tightness of the entire system.

Due to the eccentric arrangement of the uptake regions, whose inner wall tangents in the flange region come to lie on top of one another, a step is avoided there in the transition. Consequently, the two uptake regions, and optionally the transition, form a flat inner wall construction, which no longer has the tightness problems known in the prior art.

The concept of the planar region, as it is used according to the invention, is to be viewed against the background that circles contacting one another tangentially (in the case of curved lines) can come into contact only at one point, in the strict mathematical sense, due to the different circular curvature. A planar region in the sense of the present invention will thus be understood as the region extending on both sides of this hypothetical point of contact, in which the differences in curvature between the two uptake regions and the transition still do not lead to deviations; if deviations occur either the step that is formed at the transition or the deviation from the ideal shape in the design of the pipe clamp cannot be compensated for by the later clamping when joining, and thus a tightness can no longer be obtained.

Also, the particular planar region can be configured constructively up to a certain distance from the clamping slot actually as a planar region in the sense that no step is formed in the longitudinal direction of the pipe course at the transition. In this way, the inner shape of the pipe clamp does not deviate from the theoretically necessary ideal shape, with which an optimal tightness and uptake of the two lines of different shape can be achieved. The tightness of the system is not compromised in this way, however, within the scope of a certain design tolerance.

The pipe clamp can be formed of a sheet metal or of a plastic material; for example, it can be injection-molded, whereby the selection of the material depends on the actual field of application (pressure load, fluid passed through it, application temperature, pipe diameter, etc.). For example, the pipe clamp according to the invention can be produced from the materials usually used for pipe clamps, such as steel, copper, brass or plastics.

With sufficiently exact designing of pipe clamps, particularly the determination of the shape of the inner wall construction of the pipe clamp with respect to the fluid lines to be taken up, the clamping slot can be completely closed, if necessary, so that the still remaining region of the clamping slot is also fluid-tight, without it being necessary to use a sealing piece. In many applications of the invention, a sealing piece can be dispensed with, since it is not possible to use a gasket due to the fluid pressures, the manufacturing tolerances for the pipes as well as due to problems with the fastening.

However, the invention is further characterized in that it does have a sealing piece in the flange region for sealing the clamping slot against leakage of a fluid passed through the lines.

Thus, the sealing piece can be a tongue seal applied to an inner wall construction of the clamp in the region of the clamping slot, as it is also known in a similar way or the same way from pipe clamps of the prior art. These tongues can be, e.g., a very thin metal foil, a plastic foil or the like. Extremely thin, hard metal foils, which have proven particularly favorable for a tight seal, are particularly preferred. The tongue seals used for such type of sealing piece should have a width which is equal to or smaller than that of the planar region, as well as a thickness which assures a tight seal between the sealing plate and lines. The tongue seal should have a depth (referred to the longitudinal direction of the pipe clamp), which is smaller than that of the pipe clamp, so that its edges do not reach up to the borders of the uptake regions. In this way, the uptake regions can be tightly sealed with the tongue seal when the pipe clamp is clamped.

Alternatively or additionally, it is also possible that the sealing piece can be a sealing lip applied to an inner wall construction of the clamp in the region of the clamping slot. This is introduced into the clamping slot in the assembly of the pipe clamp according to the invention and is comprised of an elastic material, for example a rubber, which is pliable due to its compressibility when the pipe clamp is clamped to the lines and thus fills the clamping slot over its entire width.

In order to assure a good tightness also in the region of the transition, it is particularly preferred that the two uptake regions are formed in one piece with the transition. This can be achieved, for example, by starting from a common workpiece, in which the transition will be introduced by punch-outs or the like, or in the case of castable or injection-moldable materials such as plastics or similar materials, a mold is used which serves commonly for shaping the two uptake regions and the transition.

The lines that can be joined with the pipe clamp according to the invention and thus the uptake regions can have different shapes. Thus, in a simple embodiment, the uptake regions are of circular shape, and the two lines to be joined have different diameters. It is also possible, however, that the uptake regions are of shapes with multiple angles. In this way, lines or pipes of different types can be mounted simply and joined tightly together, as long as a region of the line shape is found which can produce a planar or essentially (see above) planar region employed in an eccentric arrangement of the two uptake regions for the pipe clamp. All types of mixed shapes are thus possible. Therefore, a square pipe can be connected to a hexagonal pipe, whereby the arrangement of the uptake regions relative to one another should be produced such that a planar region can be formed with one flat side of the square and one flat side of the hexagon. Basically, the most varied shapes can be considered, e.g., triangle, square, pentagon, hexagon or octagon shapes, as well as irregularly shaped lines, for example, those with impressed grooves for assuring a specific preferential orientation.

The fastening of the pipe clamp can be produced in different ways. Thus, a flange lock, which is known from the prior art, can be used. It may have: two flange segments extending essentially radially from the end segments of the uptake regions with openings lying opposite one another and at least one screw projecting through the openings lying opposite one another of these flange segments for clamping the pipe clamp around the lines by means of a nut placed on the screw. The openings lying opposite one another serve for guiding the screws through. Conventional flange locks have two openings in each radially protruding flange segment, which lie opposite two openings in another flange segment, so that overall, two screw-nut assemblies are used for clamping the pipe clamp.

The fastening can be produced by means of two band clamps, which are placed around the uptake regions on the outside and compress the clamping slot when they are pulled together, and the pipe clamp according to the invention clamps the lines.

In order to prevent a subsequent flow of material in the region of the end segments/flange segments, which would involve a warping of the shape and thus have an adverse affect on the tightness seal, means for preventing this re-flow may also be disposed on the flange lock. For example, angle pieces of sheet metal can serve for stabilization at the transition.

The lines to be joined can be flexible tubings or pipes or the like.

The fluid that is passed through can be a liquid, but may also be a gas or an aerosol. For example, the aerosol can be engine exhaust, if the pipe clamp according to the invention is used in exhaust systems for internal combustion engines A particularly preferred field of application of the pipe clamp according to the invention is use in exhaust systems of trucks.

The pipe clamp according to the present invention makes possible in a simple construction a basic improvement in the tightness of the connection produced with it. The usual components of simple pipe clamps may also be employed here, and the mounting is no different than for conventional pipe clamps, so that no additional training expense is necessary in conversion to this pipe clamp system.

The invention will be explained in more detail below on the basis of concrete examples of embodiment, wherein reference is made to the appended drawings, in which the following is represented:

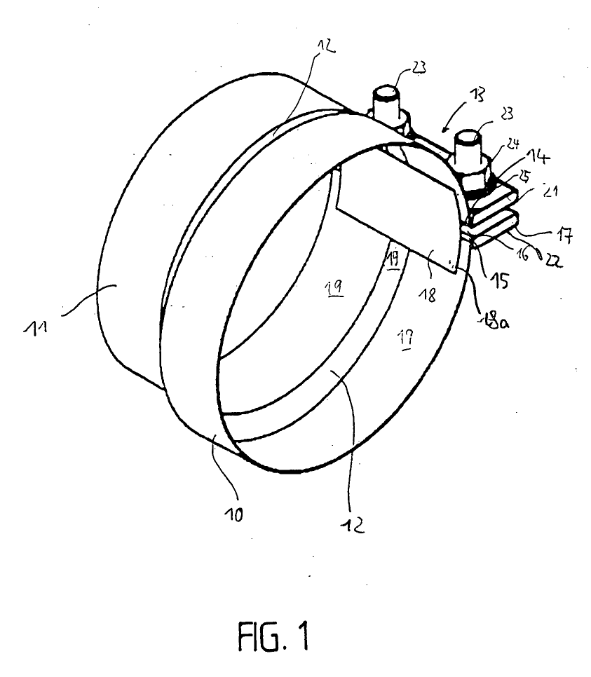

FIG. 1 shows in perspective view a first embodiment of the pipe clamp according to the present invention;

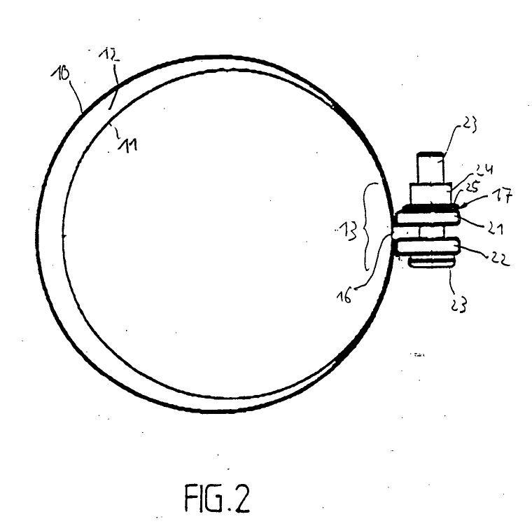

FIG. 2 shows a lateral view (through the opening of the pipe clamp) of the pipe clamp according to the embodiment of FIG. 1;

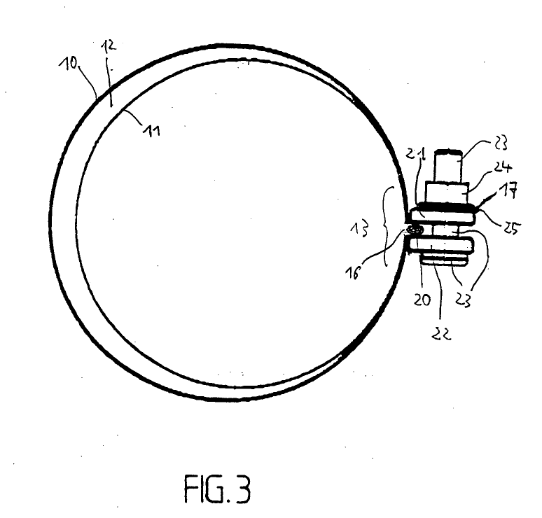

FIG. 3 shows another lateral view of a pipe clamp with a sealing piece which is modified relative to FIG. 2;

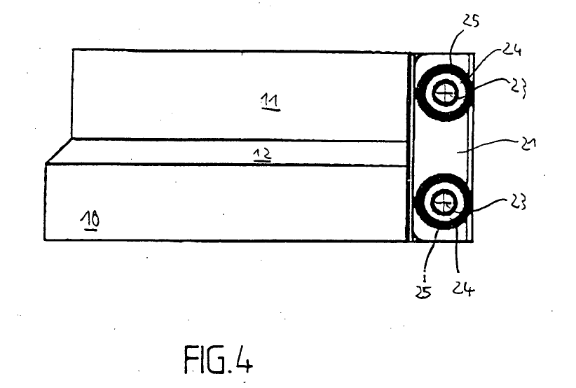

FIG. 4 shows a top view onto a pipe clamp according to the invention according to the embodiment of FIG. 1; and

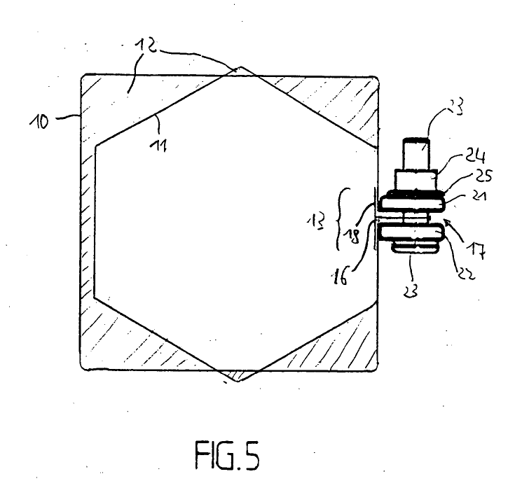

FIG. 5 shows another embodiment of a pipe clamp according to the present invention for connecting multi-angled pipes.

FIG. 1 shows a first embodiment of the present invention. The pipe clamp shown therein has a first uptake region 10 and a second uptake region 11, which are connected via a transition region 12. The transition 12 is an oblique part which is integrally incorporated in the wall construction of the pipe clamp and which produces a step between the two uptake regions. It is understood that a straight-running transition may also be used instead of an oblique part, so that the two lines to be joined can directly abut one another. Due to the eccentric arrangement of the two uptake regions with respect to their central point, the step formation is lost in the flange region 13 of the pipe clamp. There, the end segments 14, 15, which run over the entire depth of the pipe clamp, i.e., both uptake regions and optionally the transition, form between them a clamping slot 16. In the embodiment shown, a flange lock 17 lies with its elements on both sides of the clamping slot 16. A flange segment 21 essentially projecting radially to the uptake region is arranged directly at the end segment 14, while another flange segment 22 is arranged at end segment 15. Each of the two flange segments 21 and 22 provide two openings (not shown), through which are guided screws 23. The screws 23 are screwed down with nuts 24 and plain washers 25 and make possible in this way a clamping of the pipe clamp with a change in the width of the clamping slot 16. In the region of the flange, the inner wall construction 19, which extends over both uptake regions and the transition, is essentially planar, so that here the pipe clamp can be applied in form-fitting manner to both of the pipes to be connected. In order to assure tightness in this region, a tongue seal 18 (as is shown in FIG. 1), which does not cover the clamping slot over the entire depth of the pipe clamp, can [be used]. The edges 18a of the tongue seal 18 are set back relative to the outer borders of the uptake regions, in order to assure their tightness.

FIG. 2 shows the embodiment of FIG. 1 in a lateral view, whereby the eccentricity of the two uptake regions 10 and 11 can be clearly recognized. The same reference numbers will characterize here the same elements of the invention. It can be very clearly recognized that in the flange region 13 the curvatures of the two uptake regions practically run the same course, based on the eccentricity, and thus form an essentially planar region, which has fewer tightness problems than conventional pipe clamps of the prior art.

FIG. 3 shows another embodiment of the present invention, in which a sealing lip 20 is inserted in the clamping slot 16, instead of a tongue seal 18. When the pipe clamp is clamped by means of screws 23 and nuts 24, the sealing lip 20, which is comprised of a compressible material such as rubber, is compressed such that it presses against the opening found between the abutments of the two pipes and tightly seals it.

FIG. 4 shows the step construction of the two uptake regions through transition 12, but this gradation is not present in the right-hand region of FIG. 4 according to the invention, since the two uptake regions are arranged eccentrically. The transition can also be produced here with a right angle, so that transition 12 forms a wall running in the plane of the figure.

FIG. 5 finally shows another embodiment, in which a first uptake region 10 is square and a second uptake region 11 is hexagonal. Both uptake regions are mounted eccentrically, insofar as they are aligned flush with one another, each by one edge. The transition 12 has a clearly more complex shape than in the case of the round embodiments of the pipe clamp, which were described previously, so that if necessary, special manufacturing techniques and/or materials must be used for the production of this pipe clamp.

1. A pipe clamp for connecting two fluid lines of different shapes, having:
a first uptake region for the uptake of a first line of a first shape;
a second uptake region for the uptake of a second line of a second shape;
a transition for the fluid-tight connection of the first and second uptake regions;
a flange region with end segments of the first and second uptake regions and of the transition, wherein the end segments form between them a clamping slot on either side; and
a fastening for clamping the first and second uptake regions around the first and second lines at the clamping slot wherein the first and second uptake regions are eccentrically arranged relative to one another, so that the transition and the first and second uptake regions form a planar region next to one another without a step in the flange region.

2. The pipe clamp according to claim 1, further comprising a sealing piece in the flange region for tightly sealing the clamping slot against leakage of a fluid passed through the first and second lines.

3. The pipe clamp according to claim 2, wherein the sealing piece is a tongue seal applied to an inner wall construction of the clamping slot.

4. The pipe clamp according to claim 3, wherein the tongue seal has a width which corresponds to that of the planar region, has a depth that is smaller than the depth of the pipe clamp in a longitudinal direction, and has a thickness which assures a tight seal between the tongue seal and the first and second lines.

5. The pipe clamp according to claim 2, wherein the sealing piece is a compressible sealing lip in the clamping slot.

6. The pipe clamp according to claim 1, wherein the first and second uptake regions are formed in one piece with the transition.

7. The pipe clamp according to of claim 1, wherein the first and second uptake regions are of circular shape with different diameters.

8. The pipe clamp according to claim 1, wherein the first and second uptake regions are shaped for multiple angles.

9. The pipe clamp according to claim 1, wherein the fastening is a flange lock comprising:
two flange segments projecting essentially radially from the end segments of the first and second uptake regions; and
at least one screw projecting through openings of the two flange segments lying opposite one another for the clamping of the pipe clamp around the first and second lines.

10. The pipe clamp according to claim 1, the first and second lines to be joined are pipes.

11. The pipe clamp according to claim 1, the first and second lines to be joined are flexible tubings.

12. The pipe clamp according to claim 2, wherein the fluid which is passed through is a liquid.

13. The pipe clamp according to claim 2, wherein the fluid which is passed through is a gas or an aerosol.

14. The pipe clamp according to claim 13, wherein the aerosol is an engine exhaust.

15. The pipe clamp according to claim 1, wherein the transition runs at a right angle to an inner wall construction of the first and second uptake regions.
